(19) United States
(12) Patent Application Publication
(10) Pub. No.: US 2005/0198542 A1
(43) Pub. Date: Sep. 8, 2005

(54) Method and apparatus for a variable memory enable deassertion wait time

(76) Inventors: David Freker, Sacramento, CA (US); Anoop Mukker, Folsom, CA (US); Zohar Bogin, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/796,366

(22) Filed: Mar. 8, 2004

(51) Int. Cl. G06F 1/32; G06F 1/26

(52) U.S. Cl. 713/320

(57) ABSTRACT

An integrated circuit designed to be coupled to a suspendable memory, the integrated circuit comprising a memory enable deassertion delay (MEDD) logic setting a wait period for the deassertion of a memory enable signal after completion of a memory operation. The wait period is chosen for a preferred latency versus power savings tradeoff.

### FIELD

Embodiments of the present invention relate to memory controllers, and more particularly to controllers for dynamic random access memory.

### BACKGROUND

In Synchronous DRAM memory (including SDR, DDR, DDR2, etc.) and other DRAM capable of standby low power modes, an activating pin, usually referred to as Clock Enable (CKE) is used to power up the memory to enable access for writing or reading.

The memory, when not in use, goes into a stand-by or active power down mode, during which it consumes less power. In order to access the memory for reading or writing, the CKE signal has to be asserted. The CKE signal remains asserted while the memory goes from standby to active state, and until the read or write operation is completed. Once the memory operation is completed, the CKE signal is de-asserted.

In the prior art, the CKE signal is deasserted immediately after completion of the read or write operation, to maximize power savings.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram of a circuit including memory.

FIG. 2 is a block diagram of the clock enable (CKE) controller.

FIG. 3 is a flowchart of one embodiment of setting the configurable MEDD.

FIG. 4 is a flowchart of one embodiment of using the system.

FIG. 5 is a timing diagram of one embodiment of the adjustable CKE range for a read operation.

FIG. 6 is a timing diagram of one embodiment of the adjustable CKE range for a write operation.

### DETAILED DESCRIPTION

A method and apparatus for providing a programmable memory enable signal, in a memory that can be put into a stand-by or low power state is described. The memory enable signal is used to enable operations on the memory, such as reading from and writing to the memory. The memory enable signal, in one embodiment a clock enable (CKE) signal, is asserted, to wake up the memory. The memory enable signal is then maintained in an asserted state while the memory operation is completed.

In the prior art, immediately after the completion of the memory operation, the memory enable signal is deasserted. However, in practice, a subsequent access to the same memory segment is likely to occur. The memory enable signal must be asserted for at least one clock cycle prior to asserting the chip select signal, which in turn must be asserted prior to performing the memory operation. Therefore, if two sequential memory operations are sent to the same memory segment, by immediately deasserting the memory enable signal after the operation is complete, additional latency is introduced for that second cycle. Thus, delaying the deassertion of the memory enable may reduce latency. Therefore, the system waits a programmed period before de-asserting the memory enable signal.

In one embodiment, the programmed period is determined through testing the system. In one embodiment, the programmed period is determined based on the use of the system. For example, for a laptop or other portable system, the increase in latency may be a worthwhile trade-off for the decreased power consumption. In a system with high through-put requirements, the decreased latency is a worthwhile trade-off for the increased power consumption.

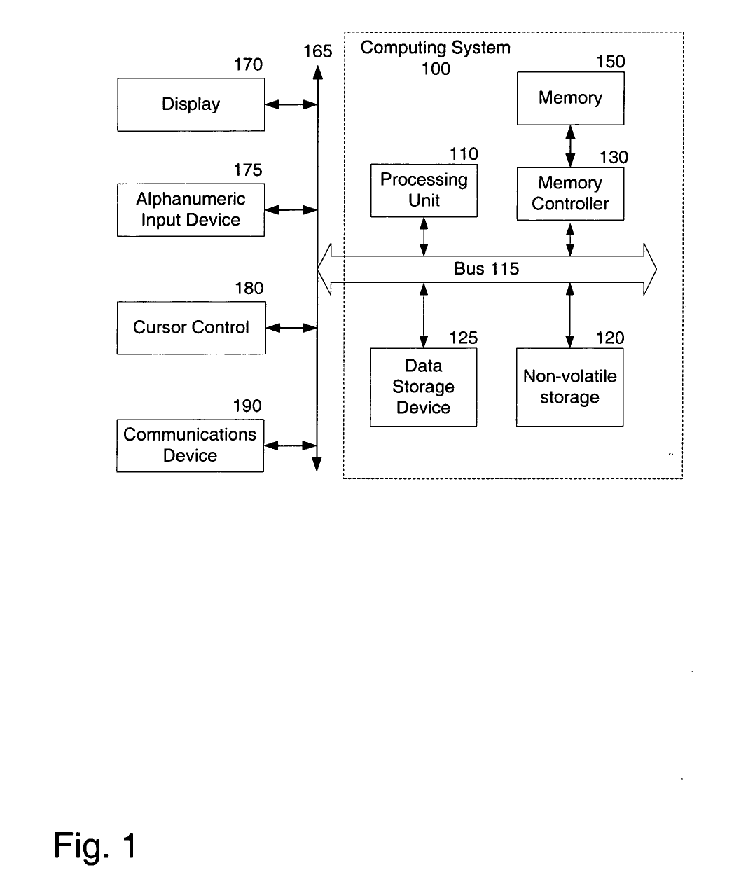

FIG. 1 is a block diagram of a computer system, including memory, that may be used with embodiments of the present invention. It will be apparent to those of ordinary skill in the art, however that other alternative systems of various system architectures may also be used.

The data processing system illustrated in FIG. 1 includes a bus or other internal communication means 115 for communicating information, and a processor 110 coupled to the bus 115 for processing information.

The system further includes a memory controller 130, to which a random access memory (RAM) or other volatile storage device 150 is coupled. The RAM is used for storing information and instructions to be executed by processor 110. The RAM 150, also referred to as main memory 150, also may be used for storing temporary variables or other intermediate information during execution of instructions by processor 110. The RAM 150, in one embodiment, may be RAM 150 which has a stand-by state as well as an active state. The memory controller 130 moves the memory 150 from the stand-by state to the active state to enable memory operations.

The system also comprises a read only memory (ROM) and/or static storage device 120 coupled to bus 115 for storing static information and instructions for processor 110, and a data storage device 125 such as a magnetic disk or optical disk and its corresponding disk drive. Data storage device 125 is coupled to bus 115 for storing information and instructions.

The system may further be coupled to a display device 170, such as a cathode ray tube (CRT) or a liquid crystal display (LCD) coupled to bus 115 through bus 165 for displaying information to a computer user. An alphanumeric input device 175, including alphanumeric and other keys, may also be coupled to bus 115 through bus 165 for communicating information and command selections to processor 110. An additional user input device is cursor control device 180, such as a mouse, a trackball, stylus, or cursor direction keys coupled to bus 115 through bus 165 for communicating direction information and command selections to processor 110, and for controlling cursor movement on display device 170.

Another device, which may optionally be coupled to computer system 100, is a communication device 190 for accessing other nodes of a distributed system via a network. The communication device 190 may include any of a number of commercially available networking peripheral devices such as those used for coupling to an Ethernet, token ring, Internet, or wide area network. The communication device 190 may further be a null-modern connection, or any other mechanism that provides connectivity between the computer system 100 and the outside world. Note that any or all of the components of this system illustrated in FIG. 1 and associated hardware may be used in various embodiments of the present invention.

It will be appreciated by those of ordinary skill in the art that any configuration of the system may be used for various purposes according to the particular implementation. The control logic or software implementing embodiments of the present invention can be stored in main memory 150, mass storage device 125, or other storage medium locally or remotely accessible to processor 110.

It will be apparent to those of ordinary skill in the art that the system, method, and process described herein can be implemented as software stored in main memory 150 or read only memory 120 and executed by processor 110. This control logic or software may also be resident on an article of manufacture comprising a computer readable medium having computer readable program code embodied therein and being readable by the mass storage device 125 and for causing the processor 110 to operate in accordance with the methods and teachings herein.

Embodiments of the present invention may also be embodied in a handheld or portable device containing a subset of the computer hardware components described above. For example, the handheld device may be configured to contain only the bus 115, the processor 110, memory controller 130, and memory 150. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of an embodiment of the present invention for such a device would be apparent to one of ordinary skill in the art given the disclosure of the embodiments of the present invention as provided herein.

Embodiments of the present invention may also be implemented in a special purpose appliance including a subset of the computer hardware components described above. For example, the appliance may include a processor 110, a data storage device 125, a bus 115, and memory 150, and only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism.

It will be appreciated by those of ordinary skill in the art that any configuration of the system may be used for various purposes according to the particular implementation. The control logic or software implementing embodiments of the present invention can be stored on any machine-readable medium locally or remotely accessible to processor 110. A machine-readable medium includes any mechanism for storing or transmitting information in a form readable by a machine (e.g. a computer). For example, a machine readable medium includes read-only memory (ROM), random access memory (RAM), magnetic disk storage media, optical storage media, flash memory devices, electrical, optical, acoustical or other forms of propagated signals (e.g. carrier waves, infrared signals, digital signals, etc.).

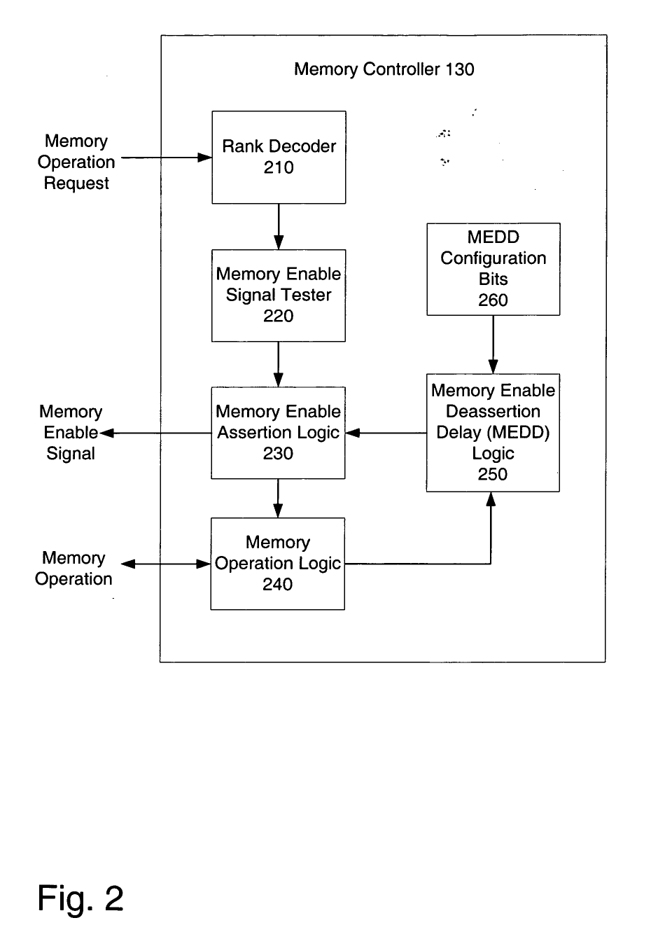

FIG. 2 is a block diagram of one embodiment of the memory controller. The memory controller 130 receives memory access requests from the processor, or other elements that may request data from memory.

The rank decoder 210 determines which memory should be enabled in response to the memory request. In one embodiment, the memory is DDR DRAM. DDR DRAMS can be put into a low power mode by negating a memory enable, the CKE pin. In this mode, the DDR DRAM's internal clocks are gated, and the DRAMs do not respond to cycles from the controller. The memory enable (CKE) is controlled on a per rank basis. A rank, in one embodiment is one side of a DIMM (Dual Inline Memory Module).

If the system has four ranks, then the controller controls four memory enable pins. While only a single pin is shown in this figure, one of skill in the art would understand that each control signal would have a corresponding enable and programming functionality. In one embodiment, all control signals have an identical delay. In another embodiment, certain control signals, for certain memories, may have a different delay. For example, if one portion of memory is primarily used for graphics, and in graphics multiple calls are often made to the same memory. In that instance, the memory that services the graphics card may have a longer delay than other memory.

The rank decoder 210 passes the signal to the memory enable signal tester, to determine whether the rank to which the current memory request is addressed is already enabled. The memory enable assertion logic 230 asserts the memory enable (CKE for DDR DRAMs) signal, in response to the memory enable signal tester, if the memory enable is not already asserted. The system must then wait for the memory to come out of stand-by.

After the memory comes out of stand-by, the memory operation logic 240 performs the operation requested.

When the operation is complete, the memory enable deassertion delay logic (MEDD) 250 delays the deassertion of the memory enable signal. In one embodiment, the MEDD 250 is stored in a programmable register. Alternatively, the MEDD may be stored in an EPROM, Flash memory, or other storage medium.

MEDD configuration bits 260 are used to set the delay in MEDD logic 250. The process of setting that delay is described below.

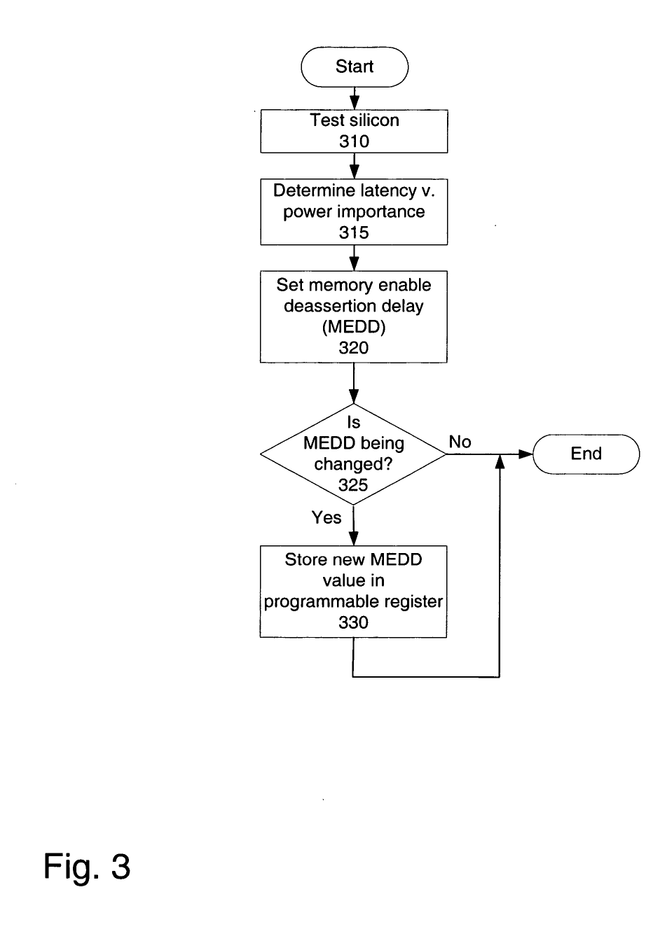

FIG. 3 is a flowchart of one embodiment of setting the configurable MEDD. The process starts at block 305. At block 310, the silicon is tested. This step is performed by engineers, to identify performance of the circuit. In particular, in one embodiment, the testing attempts to identify how often the same rank is called twice in a row. This provides the latency effect of maintaining the memory enable.

At block 315, the latency v. power consumption balance is chosen. This, again, performed by an individual, whether a user, engineer, or assembler. The latency v. power consumption balance depends on the latency advantage provided by the delay (calculated at block 310) and the function of the computing system being evaluated. In a portable computer lower power consumption may be more valuable than lower latency.

At block 320, the memory enable deassertion delay (MEDD) is set. In one embodiment, a value is stored in a programmable counter. The counter is then used to time the delay before deasserting the memory enable signal. Note that in one embodiment, the value stored in the programmable counter accounts for the time to complete the memory operation, in addition to the delay after the completion of the memory operation.

At block 325, the process determines whether the MEDD value is being changed. In one embodiment, the MEDD value is reprogrammable. If the MEDD value is reprogrammable, in one embodiment, the value is available through a user interface. In one embodiment, the user may select from a set of MEDD values. For example, the user may be presented with the following options: 0 clock cycles, 1 clock cycle, 2 clock cycles, or 3 clock cycles. In one embodiment, the maximum number of clock cycles that may be used as a delay is infinite, that is the CKE signal may be asserted all the time. If the MEDD is changed, the new value is stored in the programmable register. In one embodiment, the changed value does not take effect until the system is rebooted.

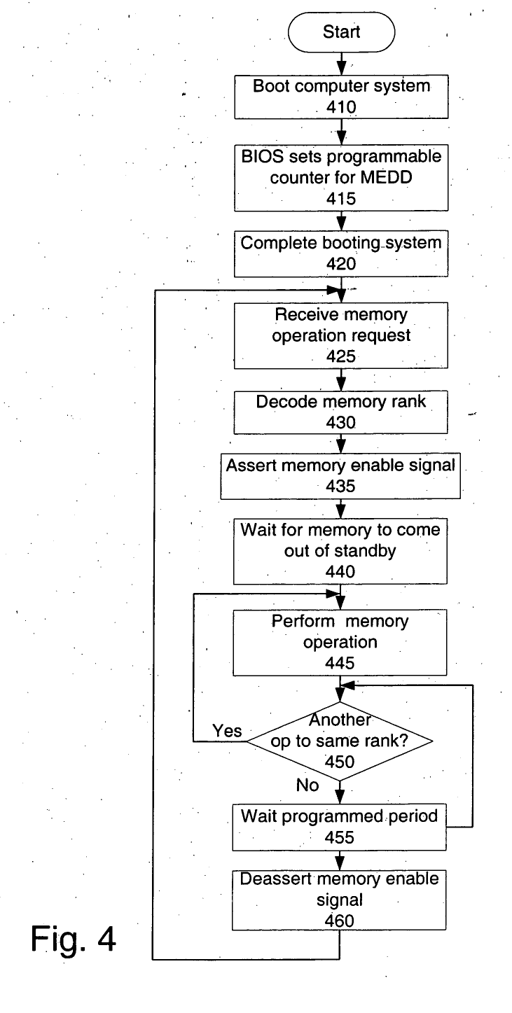

FIG. 4 is a flowchart of one embodiment of using the system. The process starts at block 405.

At block 410, the computer system is booted. At block 415, the BIOS (basic input-output system) sets the value of the programmable counter that is used for the memory enable deassertion delay (MEDD). At block 420, the booting of the system is completed.

At block 425, a memory operation request is received. The memory operation request may be received from the CPU, or any other processor or unit that may make memory requests.

At block 430, the memory rank to which the memory operation request is addressed is decoded. In one embodiment, a rank refers to the side of the DIMM to which the request is addressed. In another embodiment, the memory unit may be different, i.e. a particular memory chip, a particular chip segment, etc.

At block 435, the memory enable signal for the requested rank is enabled. In one embodiment, the memory enable signal is a clock enable signal (CKE) which connects a refresh clock to the memory, taking it out of a self-refresh, or standby, state.

At block 440, the process waits for the memory to come out of the standby state. In one embodiment, this process takes one clock cycle.

At block 445, the memory operation is performed.

At block 450, the process determines whether another operation to the same rank has been sent to the memory manager. If so, since the memory enable signal is already asserted, the process returns directly to block 445, and the memory operation is performed.

If no memory operation has been directed to the same rank, the process waits, at block 455 for the programmed delay period. The programmed delay period is the number of clock cycles before the memory enable signal is deasserted. During this waiting period, the process continuously tests whether another memory operation has been sent to the same (currently enabled) rank. If so, the memory operation is performed. In one embodiment, each memory operation resets the delay (i.e. the delay is counted as clock cycles after the last memory operation performed). Once the programmed period expires, with no memory operations, the process continues to block 460. At block 460, the memory enable signal is deasserted. The process then returns to block 425, to wait for the next memory operation request.

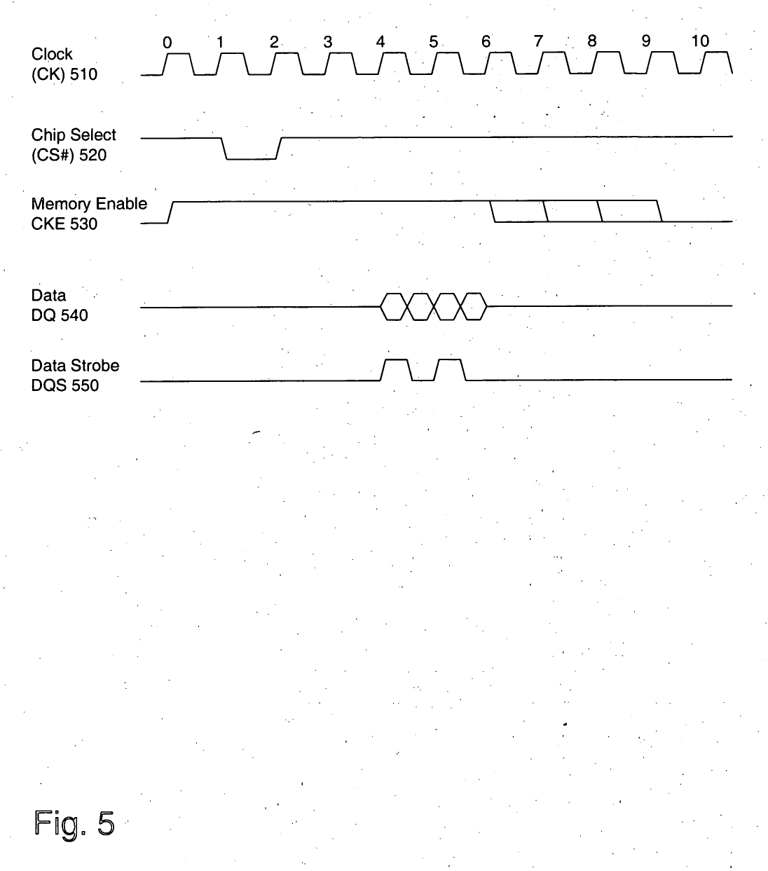

FIG. 5 is a timing diagram of one embodiment of the adjustable CKE range for a write operation. The CKE signal 530 is asserted when a cycle is directed to a particular rank. The chip select signal (CS#) 520 is asserted one clock cycle after the assertion of the CKE signal 530. The latency impact of using CKE 530 is that you need to first assert CKE 530 before you can assert CS# 520 to start the cycle. The cycle may be coming into the chipset from the CPU, or any master in the system. As can be seen the column access latency, the latency from issuing a read cycle (CS#) to when you receive read data (DQ) from the DRAM, in one embodiment, is 3 clock cycles.

Once the chip select (CS#) is processed, the actual data is transferred on data signal 540. The data strobe signal 550 wiggles with the data 540 and is used by the memory to sample data. In one embodiment, it also drives DQS 550 with read data and the chip set uses it to sample read data.

The different de-assertion times 560 for CKE 530 are showing the programmability of the CKE de-assertion time.

The range shown here is from zero to three clock cycles after the completion of the read operation (DQ). In one embodiment, the maximum number of clock cycles in the delay is on the order of 4 or 5 clock cycles. However, it certainly could be much more than that.

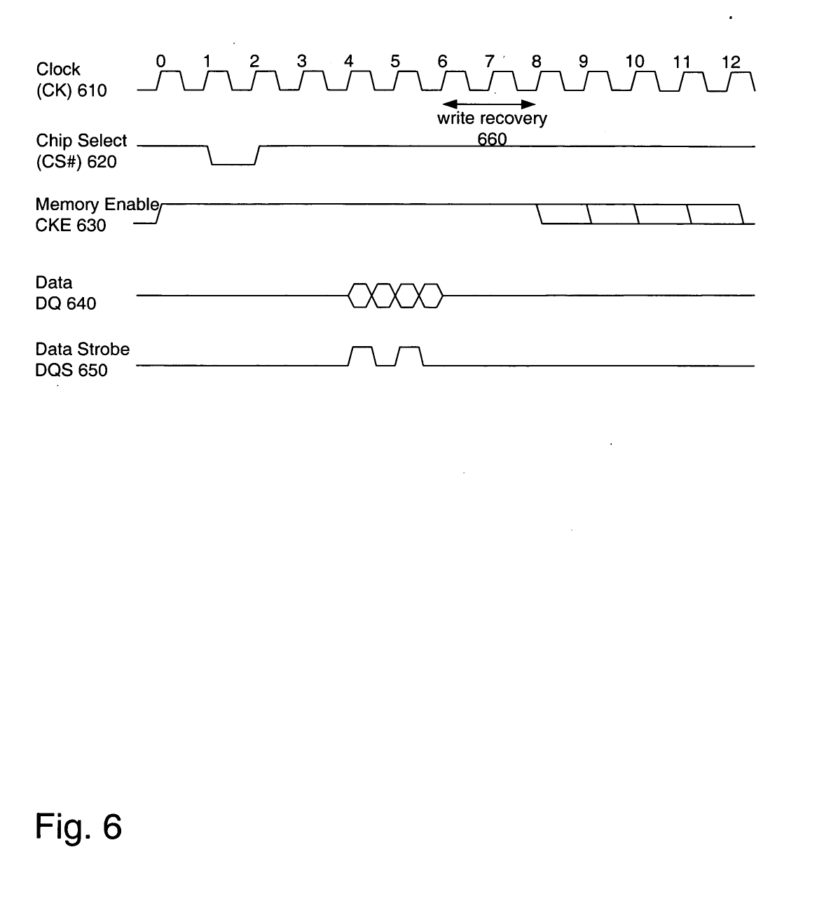

FIG. 6 is a timing diagram of one embodiment of a write operation. As can be seen, the system waits until the last piece of write data is driven (DQ 640) and a write recovery time (660) after that. The write recovery time 660 is two clock cycles for most DRAMs, but may be more for higher frequencies. After write recovery time 660, the CKE de-assertion delay is applied. In one embodiment, the system waits four to five clock cycles after write recovery.

Note that while an embodiment of the present invention has been described with respect to DDR DRAMs, the described system works with any memory capable of standby low power modes which can be dynamically enabled and disabled. Examples include synchronous dynamic random memory (SDRAM), DDR2, DDR3, etc. The memory enable signal may be a clock enable (CKE), or other signals that are applied to the memory to move the memory from standby to active state. One of skill in the art would understand how to apply the system described above to other types memory.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An memory controller comprising:
a memory enable deassertion delay (MEDD) logic to set a wait period for the deassertion of a memory enable signal after completion of a memory operation, the wait period chosen for a preferred latency versus power savings tradeoff; and
the memory enable signal used when reading from and writing to the memory.

2. The memory controller of claim 1, wherein the memory comprises double data rate (DDR) dynamic random access memory (DRAM).

3. The memory controller of claim 1, wherein a setting for reading is different from the setting for writing to the memory.

4. The memory controller of claim 1, wherein the MEDD is set using a counter.

5. The memory controller of claim 4, wherein the counter is a programmable counter.

6. The memory controller of claim 4, wherein the counter is a one-time programmable counter.

7. A method comprising:
testing an integrated circuit; and
setting a variable memory enable signal de-assertion (MEDD) wait time based on a preferred latency versus power savings tradeoff; and
using the memory enable signal to enable reading from and writing to a memory.

8. The method of claim 7, wherein the variable MEDD is set once, during an initial testing of a chipset.

9. The method of claim 7, wherein the variable MEDD may be adjusted during use.

10. The method of claim 7, further comprising:
during basic input-output system (BIOS) boot-up of the computer system, setting the MEDD.

11. An apparatus comprising:
a memory controller to provide access to a memory for reading and writing using a variable duration CKE signal;
the variable duration CKE signal to be asserted for access to the memory, the variable duration CKE signal set based on a preferred latency versus power savings tradeoff.

12. The apparatus of claim 11, further comprising:
a programmable memory to store a delay before deassertion of the CKE signal, making the CKE signal a variable signal.

13. The apparatus of claim 12, wherein the programmable memory is an erasable programmable read-only memory.

14. The apparatus of claim 11, wherein the programmable memory comprises a programmable counter.

15. The apparatus of claim 12, further comprising:
a basic input-output system (BIOS) to load the delay from the programmable memory into the computer system.

16. The apparatus of claim 11, wherein the memory is dual data rate dynamic random access memory (DDR DRAM).

17. A computing system comprising:
a means for moving a memory from stand-by status to active status to enable an operation to be completed on the memory; and
a programmable means for setting a delay before returning the memory to the stand-by status.

18. The computing system of claim 17, wherein the programmable means comprises a one-time programmable means.

19. The computing system of claim 18, wherein the programmable means comprises a reprogrammable means.

20. A system comprising:
dual data rate dynamic random access memory (DDR DRAM);
a programmable register;
a memory enable deassertion delay (MEDD) logic to set the programmable register to set a wait period for the deassertion of a memory enable signal after completion of a memory operation; and
the memory enable signal used when reading from and writing to the DDR DRAM.

21. The system of claim 20, further comprising:
a MEDD configuration bit to alter the MEDD.

22. The system of claim 20, further comprising:
a basic input-output system (BIOS) to load the delay from the programmable memory into the computer system.
